(19) United States
(12) Patent Application Publication
(10) Pub. No.: US 2015/0034679 A1
(43) Pub. Date: Feb. 5, 2015

(54) DEVICE FOR METERING AND CONVEYING VISCOUS MASSES

(71) Applicant: HAAS FOOD EQUIPMENT GMBH, WIEN (AT)

(72) Inventors: Johannes Haas, Wien (AT); Josef Haas, Leobendorf (AT); Stefan Jiraschek, Koenigsbrunn (AT); Christoph Jiraschek, Fredriksberg (DK)

(21) Appl. No.: 14/387,709

(22) PCT Filed: Jan. 31, 2013
(86) PCT No.: PCT/EP2013/051894

§ 371 Date: Sep. 24, 2014

(30) Foreign Application Priority Data
Mar. 29, 2012 (AT) A 381/2012

(51) Int. Cl. G01F 11/00

(52) U.S. Cl. CPC A23G 3/2007; A23G 1/045; A23G 3/021
USPC 222/265; 222/271; 222/272; 222/280; 222/281

(57) ABSTRACT

A device dispenses in a metered fashion a pumpable mass into an optionally moving carrier body in a dispensing region. The device includes a pump arrangement for conveying the mass through a dispensing opening which is provided in a dispensing body and which can be closed by positioning with respect to a first body. The dispensing body has an inner chamber and that the pump arrangement is provided in the inner chamber.

The invention relates to a device for conveying and metering pumpable masses such as viscous, thick-liquid, foamy and/or doughy masses such as, for example, creams, chocolate creams, dough or similar, in particular for foodstuffs and edible products as well as an device for the metered dispensing of a pumpable mass onto an optionally moving carrier body in a dispensing region comprising a pump arrangement for conveying the mass through a dispensing opening, which is provided in a dispensing body and which can be closed by positioning with respect to a first body.

Similar devices have been known in the foodstuffs area for a long time and published in different embodiments.

Devices of similar genre are used, for example, for applying viscous masses such as chocolate creams or similar to edible carrier bodies such as biscuits and optionally covering with a second carrier body. These edible products known in technical circles under the term “sandwich biscuits” have been produced for a long time in large quantities. In order to be able to manufacture these high quantities efficiently, a rapid and exact application of the viscous mass to the carrier body is required.

For this purpose, there are devices, for example, in which a pump conveys the masses via a supply line into a cylindrical body. Located in said body are channels through which the mass is guided outwards onto the carrier body. In the outer region of the cylindrical body, a hollow cylinder is provided, which substantially encloses the cylindrical body and is disposed rotatably around said body. The hollow cylinder further has openings through which the cream can emerge. The openings are, for example, distributed uniformly over the circumference but interrupted at regular intervals by the hollow cylindrical body. If the mass is guided into the cylindrical body by the pump arrangement, this mass can only emerge from the cylinder when a supply channel and an opening of the hollow cylinder lie one above the other or overlap one another at least partially. The carrier bodies, e.g. biscuits, are conveyed past on conveyor devices below the device. The speed of the biscuits in this case substantially corresponds to the external speed of the rotated cylindrical body.

The conveying capacity and the speed of application of the mass are in this case particularly determined by the malleability and the viscosity of the mass to be applied. In order to increase the throughput and the number of biscuits to be processed per unit time, a plurality of openings are provided next to one another in the cylindrical bodies. A central supply line in this case supplies the individual cream dispensing openings with the mass to be applied. A disadvantage with this construction according to the prior art is that as a result of the distributor system and the cream lines branching off from a central line, non-uniformities arise during the application and distribution of the masses. This non-uniformity results in greater rejects which as a further consequence has a negative influence on the efficiency of the manufacturing process.

It is the object of the invention to provide a device for conveying and metering viscous, thick-liquid, foamy and/or doughy masses such as, for example, creams, chocolate creams, dough or similar, which conveys the highest possible mass throughput, exactly and precisely metered, to the carrier bodies, which is constructed simply and cost-effectively, is easy to maintain, easy to clean, flexible in application and/or in particular is flexible in the choice of the openings for application of the viscous masses.

The object according to the invention is solved whereby the dispensing body comprises and/or has an inner chamber and that the pump arrangement is provided in the inner chamber.

Further features according to the invention are that at least one dispensing opening is provided in the dispensing body and that for dispensing the mass onto the carrier body in the dispensing region the first opening and the dispensing opening are arranged one above the other or overlapping one another, that the dispensing body has a substantially hollow cylindrical basic shape, which at least partially surrounds the inner chamber, that the dispensing body is arranged in a rotating manner around the first body and around the pump arrangement and/or that the axis of rotation substantially corresponds to the axis of symmetry of the dispensing body and/or the inner chamber.

The device according to the invention is further characterised in that a plurality of dispensing openings are provided in the dispensing body along a circumferential circle, that the tangential speed of the dispensing body on its outer side substantially corresponds to the motion speed of the carrier body, that the first body is configured substantially following the inner side of the inner chamber of the hollow cylindrical dispensing body and/or that the dispensing openings are closed outside the dispensing region by the first body.

It can further be provided according to the invention that a plurality of dispensing openings are arranged in parallel, that a group of dispensing openings are provided per dispensing region, wherein the respective dispensing openings of one group are movable one after the other by movement of the dispensing body into the respective dispensing region, that the dispensing openings of one group are each arranged along a circumferential circle of the dispensing body, that a plurality of dispensing regions are provided, that the circumferential circles run substantially parallel to one another and that the circumferential circles run at least partially through respectively one dispensing region, and/or that one pump arrangement is provided per dispensing region, per group of dispensing openings and/or per circumferential circle.

Features according to the invention are also that the dispensing body has a plurality of groups of dispensing openings and a cylindrical inner chamber, that the dispensing openings of one group are arranged along a circumferential circle of the dispensing body, that a pump arrangement is provided in the inner chamber per group of dispensing openings, which conveys the mass from a mass supply line to the first opening, that the dispensing body is arranged rotatably around the pump arrangement and around the first body, that a conveyance of the mass into the dispensing region is accomplished when the first opening and the dispensing opening at least overlap one another and/or that the conveyance through this same dispensing opening (5) is stopped when this is closed by the first body.

Furthermore, it can be provided that the pump arrangement comprises driven conveying means and that the conveying means are optionally driven via shafts by a pump drive, and that at least two, preferably all the pump arrangements are driven by the same pump drive and/or the same shafts, that a dispensing drive is provided for turning the dispensing body and/or that the drive of the pump arrangements and the drive of the dispensing body is accomplished separately or is separately controllable.

An advantage of the present invention is that the mass is supplied to each individual dispensing point by its own pump arrangement. As a result, the throughput of the mass at each dispensing point is constant and largely independent of flow conditions of any distributor channels. It is advantageous if the individual pump arrangements which are preferably connected in parallel can be driven and/or are driven by a single drive.

The first openings are each differently configured depending on the application. It can thus be advantageous to make the channels formed by the first openings short, in order that, for example, the lowest possible resistances need to be overcome. Furthermore, the channels formed by the openings can also have a certain length and a certain shape in order, for example, to achieve a uniform flow profile of the mass.

For rapid and exact application of the mass to a carrier body, it is advantageous according to the invention that the application of the mass can also take place with a moving carrier body. In particular with brittle or breakable carrier bodies such as thin-walled baked goods etc. a rapid stopping and starting of the carrier body is only possible to a certain extent. The device according to the invention enables application to moving carrier bodies, uniformly moving carrier bodies, non-uniformly moving carrier bodies but also to stationary carrier bodies. In order to increase the throughput of processable carrier bodies per unit time, the device according to the invention is further suitable for simultaneously conveying the mass onto a plurality of carrier bodies at the same time. As a result of the arrangement of respectively one pump arrangement per dispensing region, the number of dispensing regions arranged parallel, next to one another can be selected flexibly.

The dispensing body with the dispensing openings fulfils a plurality of functions in the present device, which advantageously cooperate:

In a plane of rotation of a dispensing region the dispensing body has at least one, preferably a plurality of dispensing openings. In order that the mass can be conveyed through one of the dispensing openings, these must be at least partially overlapping or also arranged to coincide with the first opening of the first body. During movement of the dispensing opening, the mass is therefore conveyed through the dispensing opening as long as there is at least an overlap with the first opening—and stopped as soon as there is no longer any overlap with the first opening. As a result, the mass only flows through each dispensing opening when there is an overlap with the first opening. The edge or the margin of the dispensing opening acts as a cutting edge which cuts off the conveyed mass flow. At the same time, the edge of the first opening acts as a counter-cutting edge of the cutting movement of the dispensing opening.

Another function executed by the dispensing body is the movement of the mass in the dispensing region. In particular with moving carrier bodies, the mass must be placed exactly on the carrier body. The movement component which runs substantially parallel to the direction of movement of the carrier body is accomplished at least partially, preferably completely by the dispensing body. According to an advantageous embodiment of the present invention, the circumferential velocity of the dispensing body substantially corresponds to the transport speed of the carrier body in the dispensing region.

In a preferred application and embodiment, the device according to the invention is suitable for the industrial manufacture of sandwich biscuits. This comprises the fact that the device is controllable by a machine control and that the device is used “in-line” in a production line. Furthermore, according to this embodiment the device is suitable for conveying and for manufacturing edible products. This application applies to all disclosed embodiments of the present invention.

It should be noted that the designation inner chamber does not necessarily mean that the device itself has a hollow chamber. On the contrary, the dispensing body has an inner chamber in which further components of the device according to the invention are preferably provided. In the assembled, ready-to-use state the inner chamber is therefore at least partially filled with other components such as for example the pump arrangement or the pumpable mass.

The device according to the invention is now explained subsequently with reference to specific exemplary embodiments.

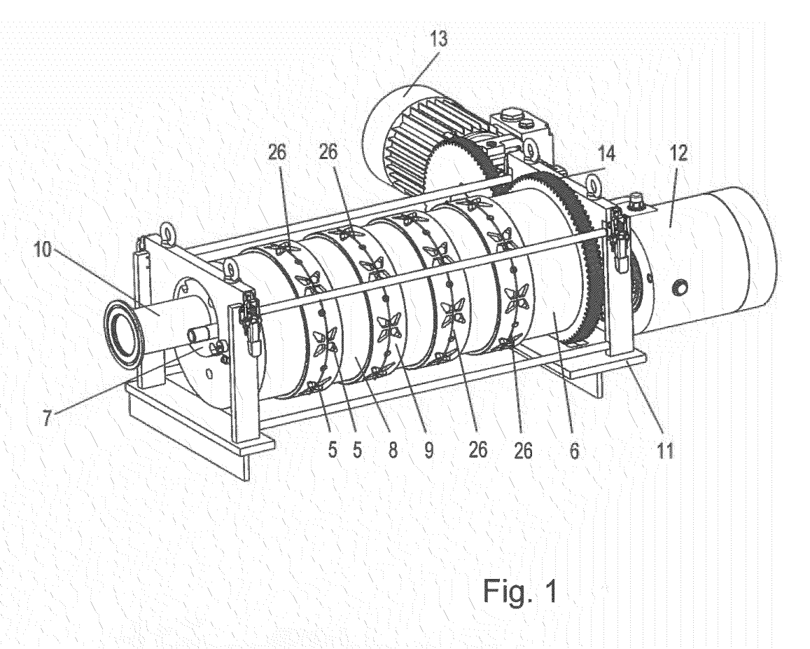

FIG. 1 shows a schematic oblique view of the crucial parts of a device according to the invention.

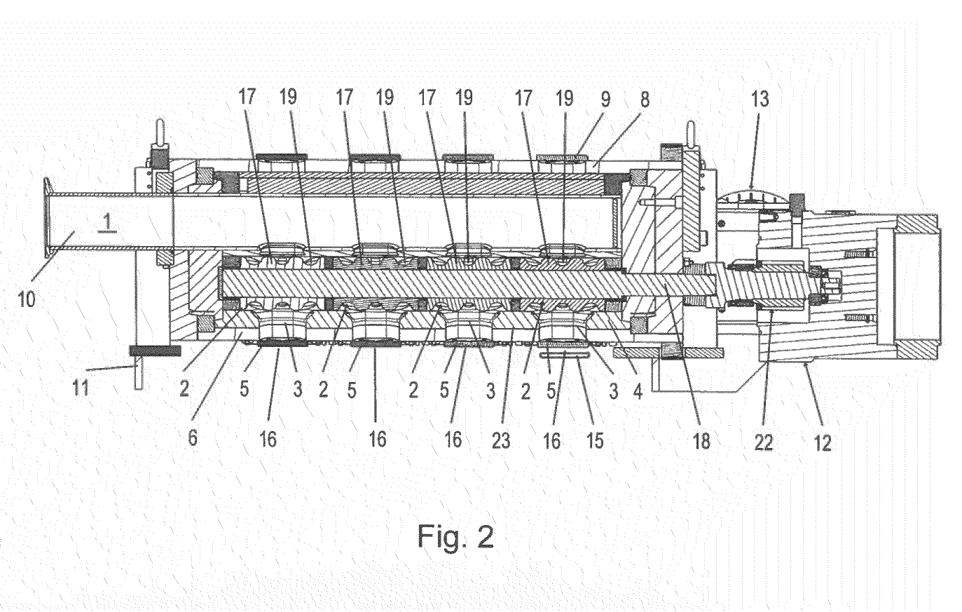

FIG. 2 shows a schematic longitudinal section of one embodiment of the device according to the invention.

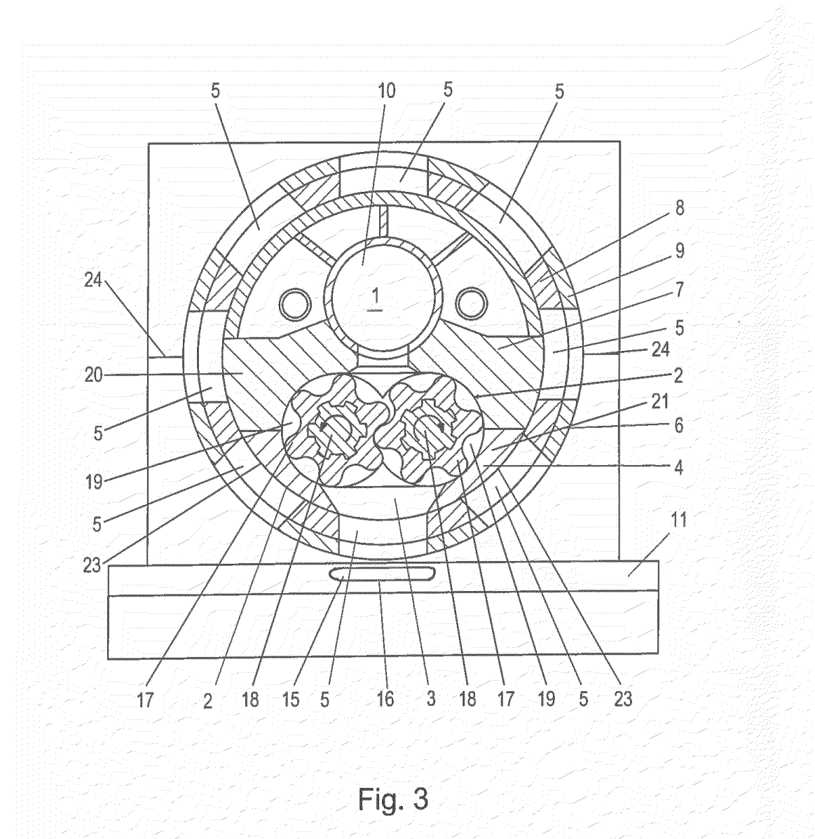

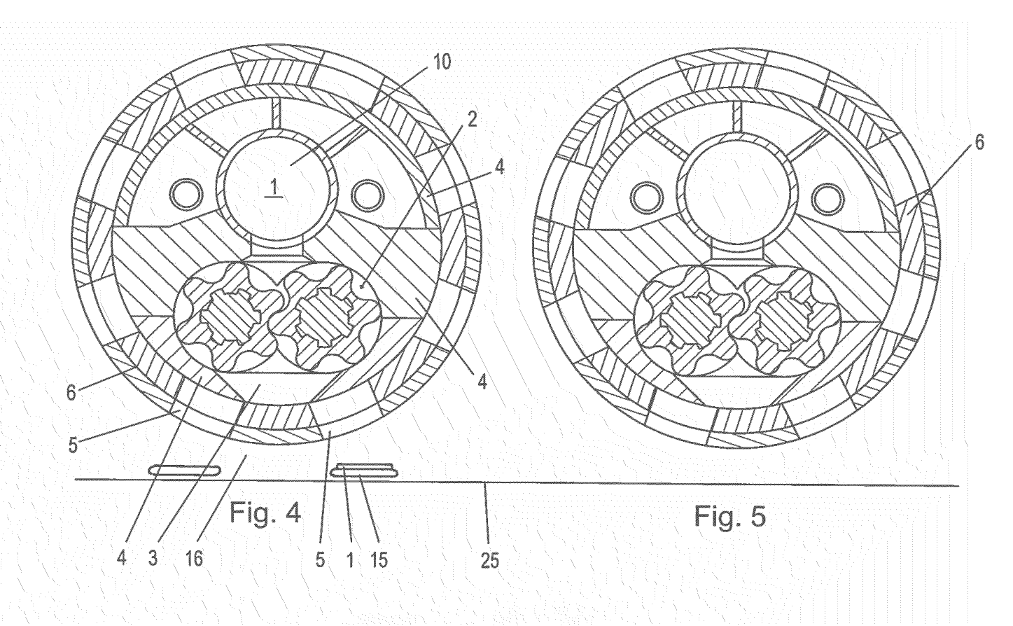

FIG. 3, FIG. 4 and FIG. 5 show schematic sectional views along a radial plane or a plane of rotation of a device according to the invention.

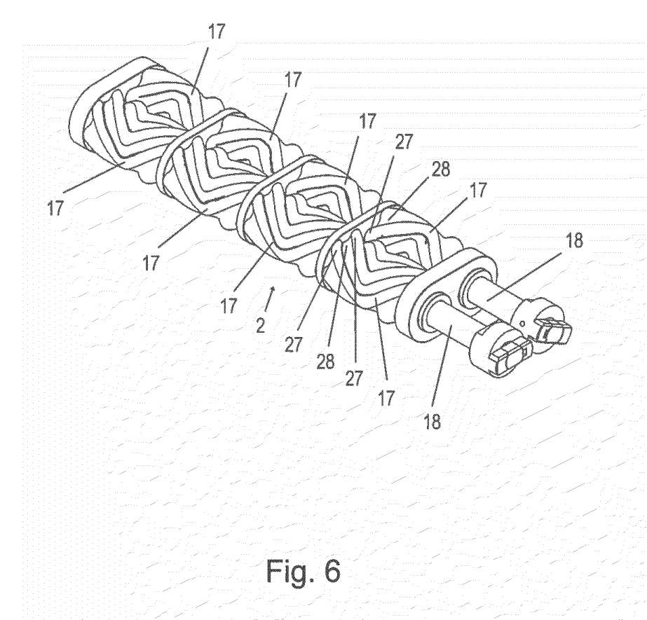

FIG. 6 shows a detailed view of parts of the pump arrangement.

FIG. 1 shows a schematic oblique view of crucial parts of the device according to the invention. In this case, a dispensing body 6 is rotatably mounted on a basic frame 11 and can be driven and/or is driven by means of a dispensing drive 13 as well as a dispensing transmission 14. Dispensing openings 5 are provided in the dispensing body 6. The dispensing body 6 further comprises a base body 8 and one or a plurality of pattern bodies 9. The pattern body 9 and the base body 8 can be executed in one piece or also, as in the present embodiment, configured as separate but interconnected bodies. Furthermore, a pump drive 12 is provided for driving the pump arrangement and/or the moving parts of the pump arrangement 2. In the present embodiment the pump arrangement lies in an inner chamber 7 of the dispensing body 6. The pump arrangement 2 conveys the mass 1 from a mass supply line 10 to the dispensing openings 5 and subsequently to one or a plurality carrier bodies 15. The carrier bodies—not shown here—are guided past the device according to the invention in order to receive the mass dispensed via the openings 5.

The pattern bodies 9 comprise the dispensing openings 5. The dispensing openings 5 can have different shapes. In the present embodiment the dispensing openings 5 comprise a plurality of partial openings. These are arranged in a star shape and have cross-shaped webs in the centre thereof. Upon passage of the mass, depending on the configuration of the shape of the outlet openings 5, the mass flow can be divided or combined again in the dispensing region. For example, with liquid masses it is possible for the liquid to run together onto the carrier body.

To this end, the dispensing body 6, which in the present embodiment is configured as a cylindrical body, is turned. In defined positions, in particular in defined rotational positions, the dispensing openings of the dispensing body 6 lie in the region of or above the first openings 3 of the first body 4. In these positions of the device, the pumped mass can emerge through the openings 3, 5 which overlap one another. Preferably the first body closes all the dispensing openings of the dispensing body with the exception of those dispensing openings which are located in the dispensing region.

The pump arrangement 2 is in this case arranged between the mass supply line and the dispensing region, where the distance covered by the mass between the pump arrangement 2 and the carrier body 15, is kept small.

A plurality of groups of dispensing openings 5 are provided along the dispensing body. These are arranged along circumferential circles of the dispensing body arranged parallel to one another. In the present embodiment, four groups of dispensing openings 5 are arranged along four circumferential circles 26.

FIG. 2 shows a longitudinal section of one embodiment of the present device according to the application. The mass 1 is conveyed by the pump arrangement 2 from the mass supply line 10 into the dispensing region 16 and optionally onto a carrier body 15. In the present embodiment four pump arrangements are provided. These each have a connecting channel to the mass supply line 10. Through the connecting channels the mass is extracted by the pump arrangement 2 and conveyed through the dispensing openings 5. Preferably in all the exemplary embodiments the mass 1 is pumped by a feed pump not shown into the mass supply line 10. Furthermore a central mass supply line 10 is provided which supplies all the pump arrangements 2. In this case, the pump arrangements are fluidically arranged between the mass supply line 10 and the dispensing regions. Per pump arrangement a partial mass flow is conveyed through the respective first opening 3 or the respective dispensing openings 5. The four parallel dispensing regions 16 therefore enable a quadrupling of the throughput. Due to the advantageous arrangement of a central mass supply line 10 and the provision of respectively one pump arrangement 2 per dispensing region 16, the mass flow in each of the dispensing regions 16 is substantially the same or determined by the respective pump arrangement. Due to the short distances in particular between the mass supply line 10 and the pump arrangement 2 and the dispensing region 16 or the respective dispensing opening 5, flow resistances are minimised. The flow profile of the mass between the pump arrangement 2 and the dispensing opening 5 can be influenced by special shaping of the inlet, in particular through the shaping of the first opening 3. According to FIGS. 3 to 5, the pump arrangements 2 each comprise conveying means 17 which in the present embodiment are configured as roll-shaped bodies having intermeshing surfaces. The conveying means 17, in particular the rollers, are driven by shafts 18. In the present embodiment respectively four conveying means are driven by one shaft 18. A second shaft 18 which rotates in the opposite direction to the respectively other shaft is also provided with four conveying means 17. Both shafts are driven by a pump drive 12. Optionally one pump transmission 22 is provided to transit a rotary movement of one drive to a plurality of shafts. According to the invention, however, it can also be provided that through the choice of different pump arrangements, a single shaft is sufficient to supply a plurality of adjacently disposed dispensing regions with masses 1.

The first body 4, the mass supply line 10 and the pump chamber 19 are arranged substantially in a fixed position and/or at least indirectly connected to the base frame 11. The dispensing body 6 is arranged in a rotating manner around the said parts 4, 10 and 19 and driven by a dispensing drive 13. The axis of rotation of the dispensing body 6 substantially corresponds to the principal axis of extension of the cylindrical dispensing body. In particular the axis of rotation of the cylindrical inner chamber 7 and the axis of rotation of the dispensing body 6 coincide. Consequently during rotation of the dispensing body 6 a sliding contact is obtained along a contact surface 23 between the first body 4 and the dispensing body 6.

FIG. 3 shows a schematic view of a section of the device according to the invention along a plane of rotation and/or along a circumferential circle of the cylindrical dispensing body 6. In this case, a dispensing body 6 with a group of dispensing openings 5 is arranged movably on the base frame 11. The dispensing body 6 comprises a base body 8 and a pattern body 9. In the present embodiment, the base body 8 and the pattern body 9 are designed as concentrically arranged hollow cylinders. The dispensing openings extend approximately in the radial direction from the inner chamber 7 of the dispensing body 6 towards the outside. In this case, as in the present embodiment, a change in the cross-section of the dispensing opening can be provided. For example, the opening in the pattern body 9 has a different cross-section from that in the base body 8. Outlet parameters such as the outlet speed, the outlet quantity, the shape of the emerging mass flow and other parameters can be determined and varied subsequently by exchanging the pattern bodies 9. The first body 4 is provided in the inner region of the dispensing body 6, in particular in the inner chamber 7. This comprises one or plurality of first openings 3. In the position shown in the dispensing region 16 the first opening 3 and the dispensing opening 5 lie adjacent to one another so that the mass 1 can be conveyed through both openings. The first body 4 is arranged substantially fixed relative to the base frame 11. During turning and/or movement of the dispensing body 6, the first body 4 remains substantially at rest. The first opening 3 also remains substantially unmoved and/or close to the dispensing region 16. The pump arrangement 2 conveys the mass 1 from a mass supply line 10 in the direction of the first opening 3. In the present embodiment the pump is designed as a gear wheel pump or gear roller pump whose operating principle substantially corresponds to that of an external gear wheel pump. According to the invention however, other pumps can be provided, which are suitable for conveying the mass onto the carrier body. Examples are eccentric rotor pumps, rotary piston pumps, eccentric screw pumps, impellers, screw conveyers, piston pumps, radial piston pumps, threaded spindle pumps, rotary vane pumps, profile roller pumps or similar.

In the present embodiment two intermeshing conveying means 17 disposed on two contra-rotating shafts 18 are provided. These are designed as roller-shaped and have an external shape which can be brought into engagement with the external shape of the other second conveying means 17. In the embodiment shown therefore the right-hand shaft 18 and the right-hand conveying means 17 would rotate clockwise and convey the mass along the pump chamber 19 in the direction of the first opening 3. The left-hand shaft rotates in the opposite direction and conveys the mass on the left-hand side in the direction of the first opening, where it is combined with the mass flow of the right-hand side. During rotation of the conveying means the two roller-shaped conveying means are in engagement with one another and thus seal the region between the conveying means 17.

The mass 1 is subsequently conveyed from the first opening 3 to the dispensing opening 5 in order to then emerge and optionally arrive at the carrier body 15. However, this emergence only takes place when the first opening 3 and the dispensing opening 5 are arranged adjacently and/or overlap one another. In one position in which the first opening 3 is closed by the dispensing body 6, the conveyance and/or the emergence of the mass 1 through this opening is interrupted. Through specific movement and/or rotation of the dispensing body and arrangement of the dispensing openings in the dispensing body, a periodic conveyance and/or dispensing of the mass 1 in the dispensing region 16 and optionally onto the carrier body 15 can take place. By selecting the size of the first opening 3 and the dispensing opening 5 and by selecting the motion speed, in particular the rotational speed of the dispensing body 6 in which the dispensing openings 5 are arranged, the dispensing time and the dispensing speed and other parameters can be varied.

According to the present embodiment, the mass 1 is conveyed by the pump arrangement 2 through the first body. The first body is in this case configured to at least partially follow the inner surface of the dispensing body 6 and touches this along the contact surface 23. The technical background is that the gap between the first body 4 and the dispensing body 6 is sealed so that no mass can pass through. The mass can only be conveyed by the pump arrangement 2 into the dispensing region 16 in the region of the openings. However, if the dispensing body is located in a rotational position in which none of the dispensing openings 5 lies in the region of the first opening 3, the dispensing opening 5 is closed and no further mass is conveyed through this opening. According to the present embodiment, one group of dispensing openings 5 is disposed along a circumferential circle of the cylindrical dispensing body 6. The dimension, in particular the width of the openings in this circumferential circle is selected in such a manner that in each rotational position at least one of the dispensing openings 5 is arranged to overlap with the first opening 3. This has the result that mass 1 is continuously conveyed by the pump arrangement 2 without any complete interruption of the mass flow occurring. However, it is completely consistent with the inventive idea to completely stop the conveyance of the mass 1 in the meantime due to larger spacings of the dispensing openings 5 or due to different shapes of the dispensing openings 5. In the present embodiment the pump chamber 19 is further surrounded by the first body 4. This is designed as multipart and has an upper part 20 and a lower part 21. The dividing line 24 of the first body 4 in which the upper part 20 and the lower part 21 touch, runs substantially through the broadest region of the pump chamber 19. For maintenance and for assembly, after separation of the dispensing body 6 from the first body 4, the upper part 20 can thus be removed in order to reach components of the pump arrangement 2. According to the invention, a plurality of dispensing openings 5 can be arranged along a plurality of parallel-running circumferential circles.

FIG. 4 shows a section as in FIG. 3 but in another rotational position. The device comprises a mass supply line 10 for supplying the mass 1 to a pump arrangement 2. The dispensing body 6 is movably arranged with at least one, preferably a plurality of dispensing openings 5. In the rotational position of FIG. 4, the first opening 3 of the first body 4 is closed by the dispensing body 6. In this position, no mass 1 is conveyed from the supply line 10 onto the carrier body 15 in the dispensing region 16. According to the invention, it can be provided that the conveyance of the mass is interrupted.

Furthermore, in the present view two carrier bodies 15 are shown schematically. These are guided along a conveying surface 25 past the device according to the invention and thereby run through the dispensing region 16. In the embodiment shown the direction of movement of the carrier body 15 is from left to right. The direction of rotation of the dispensing body 6 therefore runs anticlockwise. The carrier body 15 shown on the right is located in a position downstream of the dispensing region 16. Located on the carrier body 15 is a part of the mass 1 which was conveyed onto the carrier body in the dispensing region by the device according to the invention. The carrier body 15 located on the left is located in the direction of movement upstream of the dispensing region 16. Still no mass 1 is located on this carrier body.

FIG. 5 shows another rotational position of the device according to the invention. Here the first opening 3 and the dispensing opening 5 are positioned with respect to one another in such a manner that they are arranged in an overlapping manner. As soon as the openings overlap, it is possible for the mass 1 to be conveyed by the pump arrangement 2 in the direction of the dispensing region 16. According to the invention, it can be provided that in each rotational position of the dispensing body 6 at least one dispensing opening 5 is arranged to overlap with the first opening 3. Consequently, mass 1 is continuously conveyed in the direction of the dispensing region where it is only conveyed in each case through those dispensing openings which are located in the dispensing region 16 and/or in the region of the first opening 3. The other dispensing openings 5 are closed by the first body 4. With the arrangement of a plurality of dispensing regions provided parallel to one another, accordingly the mass 1 flows through all those dispensing openings 5 which are located in the dispensing region. The rotation of the dispensing body 6 produces the periodic opening and closing of the individual dispensing openings. Another advantage which is given by the rotatable arrangement of the dispensing body 6 is that the mass in the dispensing region is acted upon at a speed which substantially corresponds to the tangential speed of the dispensing body 6. Thus, during continuous rotation of the dispensing body, the mass 1 is on the one hand acted upon at the flow rate due to the conveyance and on the other hand at the rotational speed of the dispensing body. In particular, when applying the mass to moving carrier bodies 15, the speed of the carrier bodies 15 can thus be synchronised and/or tuned to the speed of the dispensing body 6 and subsequently to the control of the dispensing drive 13.

FIG. 6 shows a schematic view of parts of the pump arrangement 2 which is suitable for use in the device according to the invention. The pump arrangement 2 comprises conveying means 17 which can be rotated and/or driven by driven shafts 18. The conveying means 17 are each arranged in pairs. The two conveying means 17 arranged in pairs rotate in opposite directions about respectively one axis where the two axes run parallel to one another. During the rotational movement, the conveying means 17 arranged in pairs are in engagement with one another. To this end, each conveying means has combs 27 as well as free positions 28. The combs 27 and free positions 28 are designed in such a manner that the comb 27 of one conveying means 17 engages in the free position 28 of the other conveying means 17. Preferably the conveying means 17 arranged in pairs, roll on one another similarly to two gear wheels. The contact region of the two conveying means 17 is substantially sealed by the sealing engagement of the conveying means 17 arranged in pairs. The conveyance of the mass to be conveyed is accomplished on the outer side of the pump chamber not shown. To this end, as described, a mass enters into the pump chamber. This enters into the free positions 28 and is conveyed further due to the rotational movement of the conveying means in the direction of the dispensing region. In the present embodiment the combs 27 and the free positions 28 are designed as V-profile shaped. However, other profile shapes are also consistent with the inventive idea such as, for example, sloping toothed structures, straight toothed structures, corrugated toothed structures etc. It is important for the functioning mode of the pump arrangement 2 that the two conveying means 17 arranged in pairs engage with one another in such a manner that they seal the contact region and conveyance is made possible on the outer side of the pump chamber.

The combs 27 and the free position 28 preferably have a rounded profile. As a result, the shear forces in the mass to be conveyed are kept low.

In another embodiment not shown, respectively one pump arrangement is provided for respectively two dispensing openings 5 and/or two dispensing regions 16. If the conveying capacity is sufficient, the mass flow emerging from the pump arrangement 2 can be dispensed through several dispensing openings. In this case, the channels between the pump arrangement and the dispensing region should be designed in such a manner that a uniform distribution of the mass is given in order to overcome the disadvantage of the non-uniform distribution of the mass corresponding to the prior art. This is in particular achieved by the provision of channels of similar length and configurations. The remaining structure of this embodiment corresponds to the structure in FIGS. 1 to 6.

The mode of operation of the present invention is as follows:

Carrier bodies 15 are fed to the device according to the invention along a conveying surface 25 at a certain distance from one another. At the same time, the conveying surface runs at a certain distance from the outer side of the device. The axis of rotation of the dispensing body is substantially parallel to the conveying surface 25 and orthogonal to the conveying direction of the carrier bodies 15. The dispensing body 6 rotates about the first body 4, where the rotational speed on the outer side substantially corresponds to the motion speed of the carrier bodies 15. One dispensing region 16 is provided, for example, per pump arrangement. When the carrier body 15 moves through this dispensing region, the dispensing opening is moved over the carrier body by synchronization and timing of the dispensing drive 13. When the carrier body 15 and the dispensing opening 5 are located in the region of or below the first opening 3, the mass 1 is conveyed by the pump arrangement 2 onto the carrier body 15. During further movement of the dispensing body 15 and further rotation of the dispensing body 6, the mass flow is cut off or sheared by the edge of the dispensing opening and the dispensing opening 5 is closed by the first body 4. In this case, the edge of the first opening acts as a counter-cutting edge of the cutting movement of the dispensing opening. The conveyance of the mass through the relevant dispensing opening 5 is stopped and the carrier body 15 brought in contact with mass 1 is moved further along the conveying surface 25. In the meantime a subsequent carrier body is supplied to the dispensing region. If the subsequent carrier body and the subsequent dispensing opening are located in the region of the first opening, mass is also conveyed to the subsequent carrier body. In this way a plurality of carrier bodies arranged in a row in the direction of motion are provided with the mass. In this case, the spacing of the carrier bodies substantially corresponds to the spacing of the dispensing openings on the dispensing body.

In order to increase the throughput of carrier bodies to be processed, a plurality of dispensing regions 16 are arranged adjacent to one another along the conveying direction of the carrier bodies 15. Carrier bodies are also passed through these further parallel dispensing regions and thereby coated with a mass 1. Preferably its own pump arrangement 2 and its own group of dispensing openings 5 is provided per dispensing region.

As a result of the configuration of the pump arrangement according to the invention and the entire device, about 600 to 800 carrier bodies per minute can be coated or provided with a mass per dispensing region. In principle, the invention is not limited in the number of dispensing regions arranged parallel. Nevertheless, preferably about 4 to 10 dispensing regions can be provided per device. In this case, the conveying means 17 of the pump arrangement 2 are driven by continuous shafts in each case. Also the dispensing body 6 and/or the first body 4 extend over all the dispensing regions arranged parallel. Furthermore, a central mass supply line 10 is preferably provided for the entire device.

### REFERENCE LIST

1. Mass
2. Pump arrangement
3. First opening
4. First body
5. Dispensing opening
6. Dispensing body
7. Inner chamber
8. Base body
9. Pattern body
10. Mass supply line
11. Base frame
12. Pump drive
13. (Dispensing) second drive
14. Second transmission
15. Carrier body
16. Dispensing region
17. Conveying means
18. Shaft
19. Pump chamber
20. Upper part of first body
21. Lower part of first body
22. Pump transmission
23. Contact surface
24. Dividing line
25. Conveying surface
26. Circumferential circle
27. Comb
28. Free position

1-19. (canceled)

20. A device for metered dispensing of a pumpable mass onto a carrier body disposed in a dispensing region, the device comprising:
a dispensing body having a dispensing opening formed therein, said dispensing body having an inner chamber;
a pump configuration for conveying the pumpable mass through said dispensing opening of said dispensing body, said pump configuration disposed in said inner chamber; and
a first body, said dispensing opening being closed by positioning with respect to said first body.

21. The device according to claim 20, wherein:
said first body has a first opening formed therein; and
said dispensing opening is at least one dispensing opening formed in said dispensing body and that for dispensing the pumpable mass onto said carrier body in the dispensing region, said first opening and said dispensing opening are disposed one above the other or overlapping one another.

22. The device according to claim 20, wherein said dispensing body has a substantially hollow cylindrical basic shape, which at least partially surrounds said inner chamber.

23. The device according to claim 20, wherein said dispensing body is disposed in a rotating manner around said first body and around said pump configuration.

24. The device according to claim 20, wherein an axis of rotation substantially corresponds to an axis of symmetry of said dispensing body and/or said inner chamber.

25. The device according to claim 20, wherein said dispensing opening is one of a plurality of dispensing openings disposed in said dispensing body along a circumferential circle.

26. The device according to claim 20, wherein said dispensing body has a tangential speed on an outer side substantially corresponding to a motion speed of the carrier body.

27. The device according to claim 22, wherein said first body is configured substantially following an inner side of said inner chamber of said dispensing body being a hollow cylindrical dispensing body.

28. The device according to claim 25, wherein said dispensing openings are closed outside said dispensing region by said first body.

29. The device according to claim 25, wherein a group of said dispensing openings are disposed in the dispensing region, wherein said dispensing openings of one group are movable one after the other by movement of said dispensing body into the dispensing region.

30. The device according to claim 25, wherein said dispensing openings are formed in groups and each group is disposed along a circumferential circle of said dispensing body.

31. The device according to claim 30, wherein:
the dispensing region is one of a plurality of dispensing regions; and
said dispensing body has a plurality of circumferential circles each carrying said group of said dispensing openings, each of said circumferential circles runs substantially parallel to one another and that said circumferential circles run at least partially through respectively one of the dispensing regions.

32. The device according to claim 31, wherein said pump configuration is one of a plurality of pump configurations, one of said pump configurations is provided per each said dispensing region, per said group of said dispensing openings and/or per said circumferential circle.

33. The device according to claim 20, wherein:
said dispensing body has a plurality of groups of dispensing openings and said inner chamber is a cylindrical inner chamber, said dispensing body has a mass supply line;
said dispensing body has a plurality of circumferential circles, said dispensing openings of one of said groups are disposed along one of said circumferential circles of said dispensing body;
said pump configuration is one of a plurality of pump configurations, one of said pump configurations is disposed in said inner chamber for each of said groups of said dispensing openings, said pump configurations convey the pumpable mass from said mass supply line to said first opening;
said dispensing body is disposed rotatably around said pump configurations and around said first body; and
a conveyance of the pumpable mass into the dispensing region is accomplished when said first opening and said dispensing opening at least overlap one another and the conveyance through said dispensing opening is stopped when said first opening is closed by said first body.

34. The device according to claim 20, wherein said pump configuration has a driven conveying device.

35. The device according to claim 34,
further comprising a pump drive; and
wherein said pump configuration is one of a plurality of pump configuration each having shafts, at least two of said pump configurations are driven by a same said pump drive and/or a same said shafts.

36. The device according to claim 35, further comprising a dispensing drive for turning said dispensing body.

37. The device according to claim 36, wherein said pump drive of said pump configurations and said dispensing drive of said dispensing body is accomplished separately or is separately controllable.

38. The device according to claim 35, wherein one of said pump configurations is provided for respectively two said dispensing openings and/or two said dispensing regions.

39. The device according to claim 34,
further comprising a pump drive; and
wherein said pump configuration has shafts, said driven conveying device is driven via said shafts by said pump drive.

40. The device according to claim 20, wherein the carrier body is a moveable carrier body.
